(19) United States
(12) Patent Application Publication
(10) Pub. No.: US 2013/0191220 A1
(43) Pub. Date: Jul. 25, 2013

(54) Systems and Methods for Displaying Over-Scroll Regions on Electronic Devices

(71) Applicants: Terrill Mark Dent, Waterloo (CA); Maribei Romo Savournin, Kitchener (CA); Michael Stephen Brown, Kitchener (CA)

(72) Inventors: Terrill Mark Dent, Waterloo (CA); Maribei Romo Savournin, Kitchener (CA); Michael Stephen Brown, Kitchener (CA)

(73) Assignee: RESEARCH IN MOTION LIMITED, Waterloo, ON (CA)

(21) Appl. No.: 13/635,012

(22) PCT Filed: Jul. 13, 2011
(86) PCT No.: PCT/CA11/50434

§ 371 Date: Sep. 14, 2012

(51) Int. Cl. G06Q 30/02; G09G 5/34

(52) U.S. Cl. CPC G06Q 30/0267; G09G 5/34
USPC 705/14.64

(57) ABSTRACT

A method and system are provided for displaying advertising content on a mobile device by displaying an over-scroll region on a display of the mobile device, and displaying a first advertisement in at least a first portion of the over-scroll region. The method may include determining information associated with the over-scroll region, and selecting the first advertisement based on the information associated with the over-scroll region. The method may also include displaying a second advertisement in a second portion of the over-scroll region and selecting the second advertisement based on the information associated with the over-scroll region.

### TECHNICAL FIELD

The following relates generally to displaying one or more regions on electronic devices, in response to an over-scrolling input.

### BACKGROUND

Many electronic devices, including mobile devices, display only a portion of the content (e.g. document, webpage, list or other forms of data) of interest to a user at a given time on a display of the electronic device. In order to view a different portion of the content, the user can provide an input to the electronic device to display a different portion of the content.

### BRIEF DESCRIPTION OF THE DRAWINGS

Example embodiments will now be described by way of example only with reference to the appended drawings wherein:

FIG. 1 is a block diagram of an example of a display of a mobile device displaying a portion of the content of interest to a user.

FIG. 2 is a block diagram of the example shown in FIG. 1 displaying another portion of the content.

FIG. 3 is a block diagram of the example shown in FIG. 2 displaying an over-scroll region.

FIG. 4 is a block diagram of the example shown in FIG. 3 displaying an over-scroll region second portion.

FIG. 5 is a block diagram of an example of a wireless communication system.

FIG. 6 is a plan view of an example of a mobile device and a display screen therefor.

FIG. 7 is a plan view of another example of a mobile device and a display screen therefor.

FIG. 8 is a block diagram of an example embodiment of a mobile device.

FIG. 9 is a screen shot of a home screen displayed by a mobile device.

FIG. 10 is a block diagram illustrating examples of other software applications and components shown in FIG. 8.

FIG. 11 is a block diagram of an example of a configuration of an over-scroll region display application.

FIG. 12 is a flow diagram of an example of a set of computer executable instructions for displaying an over-scroll region on a mobile device.

FIGS. 13-16 are block diagrams of an example of a display of a mobile device displaying example over-scroll regions.

FIG. 17 is a flow diagram of another example of a set of computer executable instructions for displaying an over-scroll region on a mobile device.

FIGS. 18-21 are block diagrams of examples of transformations of content displayed on a mobile device.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practised without these specific details. In other instances, well-known methods, procedures and components have not been described in detail so as not to obscure the example embodiments described herein. Also, the description is not to be considered as limiting the scope of the example embodiments described herein.

Many electronic devices, including mobile devices, provide a user input in the form of a scrolling input to translate the content displayed on the device in a direction. For example, the scrolling input in an electronic device having a touch-screen display can include placing an object, such as a finger of the user, on the touch-screen display and moving the object in a direction to cause the device to scroll the content in the same direction. In one example, the device can scroll the content as long as the scrolling input is applied. In another example, scrolling can continue after the scrolling input has ended based on properties of the scrolling input (e.g. proportional to the scrolling input's rate of acceleration prior to ending, and inversely proportional to the time interval after the scrolling input has ended, to provide a dampened scrolling motion).

Given the use of scrolling, electronic devices may provide a visual indicator to the user to indicate that a boundary of the content has been reached. One such visual indicator is to allow the device to scroll beyond a boundary of the content to display an “over-scroll” region. The over-scroll region can be displayed when a scrolling input results in scrolling the content in a direction beyond one of its boundaries. In one example, the over-scroll region can remain displayed as long as the scrolling input is applied. Once the scrolling input has been removed, the content can automatically scroll back in the reverse direction such that the over-scroll region is no longer displayed. This may give the effect of having the content being displayed “snap back” to the boundary. In another example, a scrolling input can be of such magnitude that after a scrolling input has ended, the content continues to scroll past one of its boundaries. Once the scrolling has ended, the content can automatically scroll back in the reverse direction such that the over-scroll region is no longer displayed.

As discussed above, many electronic devices, including mobile devices, display an over-scroll region to provide a visual indicator to a user to indicate that a boundary of the content has been reached. The over-scroll region can be blank or dead-space of a solid colour, have the same background as the content displayed, or be a wallpaper image such as a picture or pattern. The over-scroll region does not convey much information (if any) beyond that the boundary of the content has been reached.

With the popularity of mobile devices including touch-screen displays and user interfaces that incorporate over-scroll regions, users are often attracted to the over-scroll region and deliberately apply scrolling inputs to invoke the display of the over-scroll region.

It has been recognized that methods for displaying over-scroll regions on an electronic device such as a mobile device are typically limited in the information conveyed to the user in the over-scroll region. To address this, the following describes a method, computer readable storage medium and mobile device operable to display over-scroll regions. The method includes displaying an over-scroll region on a display of the mobile device, and displaying a first advertisement in at least a first portion of the over-scroll region. The method may include determining information associated with the over-scroll region, and selecting the first advertisement based on the information associated with the over-scroll region. A portion of the over-scroll region may be selectable.

In some example embodiments, the method includes modifying the over-scroll region. The over-scroll region may be modified by increasing or decreasing the size of the over-scroll region.

In some example embodiments, the first advertisement can include an image, a tiled pattern of an image, and/or text.

In some example embodiments, the method includes displaying a second advertisement in a second portion of the over-scroll region. The method may include selecting the second advertisement based on the information associated with the over-scroll region. The second advertisement may be related to the first advertisement. The second advertisement can include an image, a tiled pattern of an image, and/or text.

The information associated with the over-scroll region may include: at least one dimension of the over-scroll region; one or more properties of a scrolling input corresponding to the over-scroll region; a duration of time or a number of times that the over-scroll region has been displayed; a comparison between information associated with the over-scroll region and information associated with another over-scroll region; statistical information; and information associated with content displayed on the mobile device.

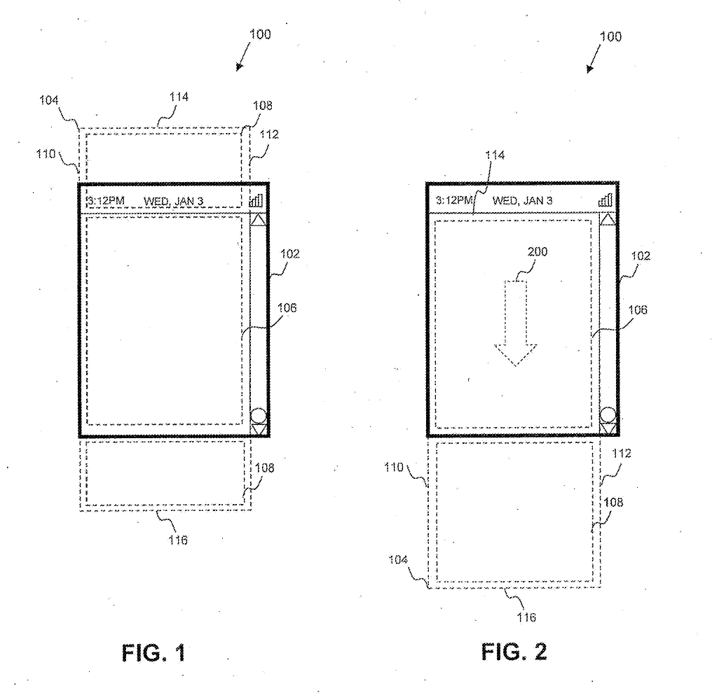

Referring to FIGS. 1-4, block diagrams of an example touch-screen display 102 of a mobile device 100 displaying content 104 are provided. The content 104 includes a displayed portion 106 and undisplayed portions 108. In the examples of FIGS. 1-4, the content 104 has a left boundary 110, right boundary 112, upper boundary 114, and lower boundary 116.

As shown in FIG. 1, the display 102 can display a displayed portion 106 of content 104. In this example, undisplayed portions 108 are above and below the displayed portion 106.

In FIG. 2, a scrolling input 200 that has been applied to scroll the content 104 can be detected by the mobile device 100 in the direction of the scrolling input 200 such that a portion of the previous undisplayed content 108 is shown on the display 102. In the example of FIG. 2, the upper boundary 114 is aligned with the upper boundary of the display 102.

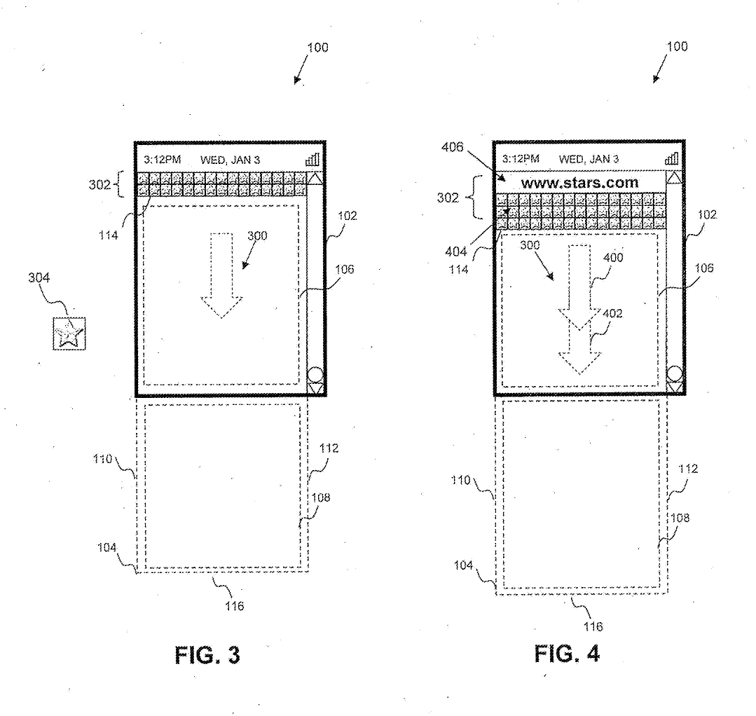

In FIG. 3, a scrolling input 300 can be performed to scroll the content 104 in the direction of the scrolling input 300 such that the content 104 is scrolled beyond its upper boundary 114 to display an over-scroll region 302. In some example embodiments, the over-scroll region 302 can display an advertisement in the form of text and/or an image such as a tiled pattern (or non-tiled pattern) of a symbol, trade-mark or other small image 304. The image can be related to a product or business of a company. It can be appreciated that by tiling a relatively small image 304 as shown in FIG. 3, the amount of data required to populate the over-scroll region 302 can be kept to a minimum. In this way, various images 304 can be provided to the mobile device 100 over-the-air, e.g. to deliver advertising content without consuming an adverse amount of bandwidth.

In FIG. 4, a scrolling input 300 includes a scrolling input first stage 400 and a scrolling input second stage 402. In response to the scrolling input 300, an over-scroll region 302 is displayed including an over-scroll region first portion 404 and an over-scroll region second portion 406. The scrolling input first stage 400 scrolls the content 104 in the direction of the scrolling input first stage 400 such that the content 104 is scrolled beyond its upper boundary 114 to display the over-scroll region first portion 404. The scrolling input second stage 402 scrolls the content 104 in the direction of the scrolling input second stage 402 such that the content 104 is further scrolled beyond its upper boundary 114 to display the over-scroll region second portion 406. The over-scroll region first portion 404 remains displayed while the over-scroll region second portion 406 is displayed in response to the scrolling input second stage 402. The over-scroll region second portion 406 can display a different type of advertisement than the over-scroll region first portion 404, in an example embodiment in the example of FIG. 4, the over-scroll region first portion 404 displays a tiled pattern of a small image whereas the over-scroll region second portion 406 displays a website address. In the example of a multi-touch touch-screen display, the website address in the over-scroll region second portion 406 can be selected to open the website using a web browser of the mobile device. By displaying both over-scroll region first and second portions 404, 406, subtle advertising can be provided by tiling the small images 304 at a minimum of distraction and consumption of bandwidth, whereas upon detecting repeated over-scroll or detection of an over-scroll position being held in one place, further advertising content can be provided. Since repeated over-scroll operations or holding an over-scroll position can be indicative of potentially higher interest in the content, the second portion 406 can include more specific or detailed content.

It will be appreciated that the over-scroll region 302 should not be limited to displaying advertisements, for example, other messages that can be in the form of patterns, images and/or text can also displayed. It can further be appreciated that the scrolling input should not be limited a touch-screen display input device, for example, other forms of inputs such as a mouse drag, trackpad scroll, trackball scroll, etc. can cause the over-scroll region 302 to be displayed.

It can therefore be seen that the over-scroll region 302 can be used to communicate information such as advertisements. It can be advantageous to display advertisements in an over-scroll region 302 because the over-scroll region 302 may inherently attract a user's attention such that the advertisement is in a location more likely to be viewed by the user. The user's inherent attraction to an over-scroll region 302 can also decrease the emphasis on the advertisement, making it less intrusive and more suitable for system-wide application. Furthermore, placing an advertisement in an over-scroll region 302 minimizes the use of space on the display 102 of the mobile device 100 that can be available to display other content, thus also minimizing the intrusiveness of the advertisement on the user. The intrusiveness of an advertisement in the over-scroll region 302 can be further minimized as the over-scroll region 302 (and thus advertisement) may only be displayed in response to a scrolling input 300 of the user. This can provide the user with the ability to control the display of the advertisement by controlling the scrolling input 300.

Examples of applicable mobile electronic devices may include, without limitation, cellular phones, smart-phones, tablet computers, pagers, wireless organizers, personal digital assistants, computers, laptops, handheld wireless communication devices, wirelessly enabled notebook computers, portable gaming devices, and the like. Such devices will hereinafter be commonly referred to as “mobile devices” 100 for the sake of clarity. It will however be appreciated that the principles described herein are also suitable to other electronic devices, e.g. “non-mobile” devices. For example, the principles herein are equally applicable to personal computers (PCs), tabletop computing devices, wall-mounted screens such as kiosks, or any other computing device that includes a display.

In an example embodiment, the mobile device 100 can be a two-way communication device with advanced data communication capabilities including the capability to communicate with other mobile devices or computer systems through a network of transceiver stations. The mobile device may also have the capability to allow voice communication. Depending on the functionality provided by the mobile device, it may be referred to as a data messaging device, a two-way pager, a cellular telephone with data messaging capabilities, a wireless Internet appliance, or a data communication device (with or without telephony capabilities).

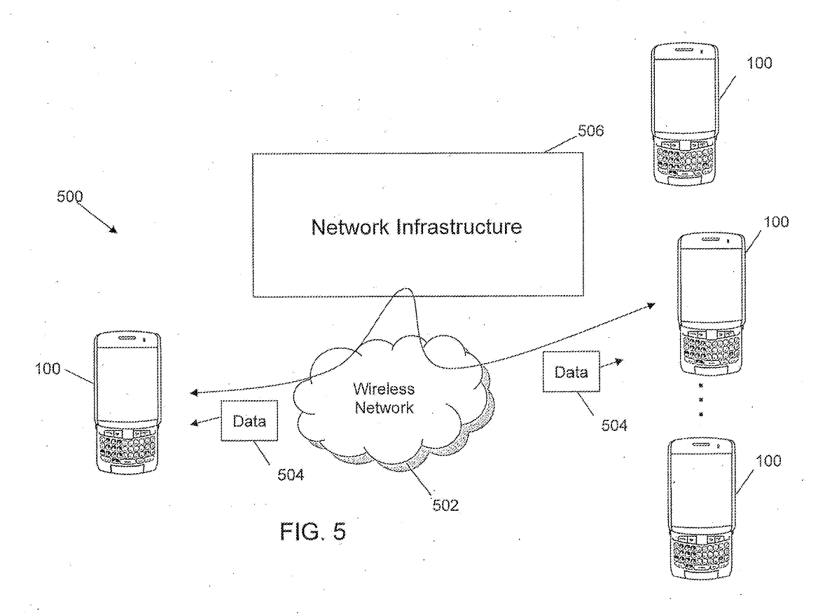

Referring to FIG. 5, an example communication system 500 is shown. The communication system 500, in this example embodiment, enables, at least in part, mobile devices 100 to communicate with each other via a wireless network 502. For example, as shown, data 504 may be exchanged between various mobile devices 100. Data 504 that is sent from one mobile device 100 to another mobile device 100 may be transmitted according to a particular messaging or communication medium, protocol, or other mechanism. For example, as shown in FIG. 5, data 504 may be sent over the wireless network 502 via a component of a network infrastructure 506. The network infrastructure 506 can include various systems that may be used by the mobile devices 100 to exchange data 504. For example, a peer-to-peer (P2P) system, a short message service centre (SMSC), an email system (e.g. web-based, enterprise based, or otherwise), a web system (e.g. hosting a website or web service), a host system (e.g. enterprise server), and social networking system may be provided by or within or be otherwise supported or facilitated by the network infrastructure 506. The mobile devices 100 may therefore send data to or receive data from other mobile devices 100 via one or more particular systems with which the mobile devices 100 are communicable via the wireless network 502 and network infrastructure 506.

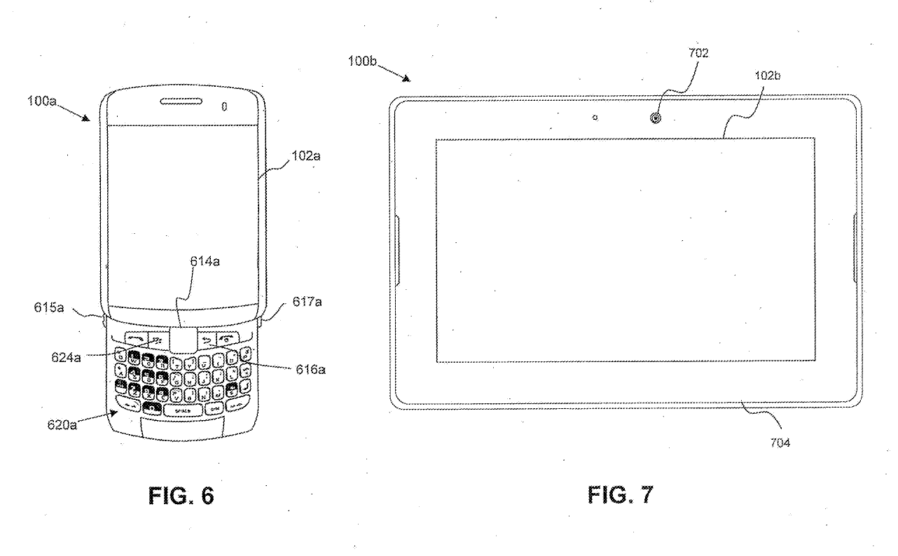

Referring to FIGS. 6 and 7, one example embodiment of a mobile device 100a is shown in FIG. 6 and another example embodiment of a mobile device 100b is shown in FIG. 7. it will be appreciated that the numeral “100” will hereinafter refer to any mobile device 100 including the example embodiments 100a and 100b, those example embodiments enumerated above or otherwise. It will also be appreciated that a similar numbering convention may be used for other general features common between all figures such as a touch-screen display 102.

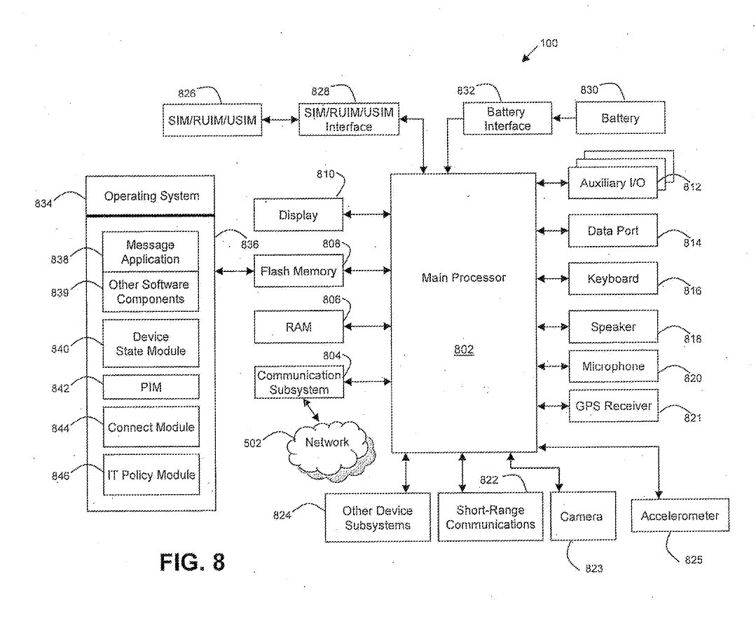

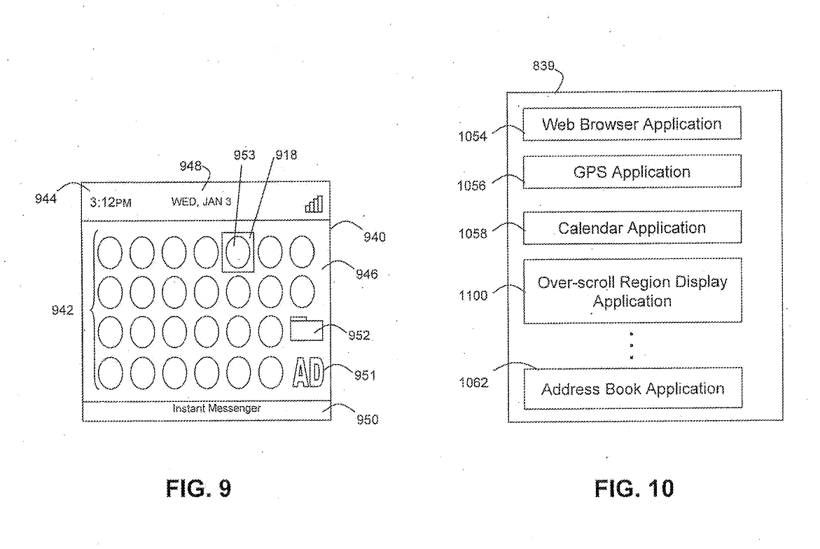

The mobile device 100a shown in FIG. 6 includes a touch-screen display 102a and a cursor or positioning device, which in this example is in the form of a trackpad 614a. Trackpad 614a permits multi-directional positioning of the selection cursor 918 (see FIG. 9) such that the selection cursor 918 can be moved in an upward direction, in a downward direction and, if desired and/or permitted, in any diagonal direction. The trackpad 614a in this example embodiment is situated on the front face of a housing for mobile device 100a as shown in FIG. 6 to enable a user to manoeuvre the trackpad 614a while holding the mobile device 100a in one hand. The trackpad 614a may serve as another input member (in addition to a directional or positioning member) to provide selection inputs to the processor 802 (see FIG. 8) and can preferably be pressed in a direction towards the housing of the mobile device 100b to provide such a selection input. It will be appreciated that the trackpad 614a is only one example embodiment of a suitable positioning device. For example, a trackball, touch-screen display, OLED, or other input mechanism may equally apply.

The touch-screen display 102a may display a selection cursor 918 (see FIG. 9) that depicts generally where the next input or selection will be received. The selection cursor 918 may include a box, alteration of an icon or any combination of features that enable the user to identify the currently chosen icon or item. The mobile device 100a in FIG. 6 also includes a programmable convenience button 615a to activate a selection application such as, for example, a calendar or calculator. Further, mobile device 100a also includes an escape or cancel button 616a, a camera button 617a, a menu or option button 624a and a keyboard 620a. The camera button 617a is able to activate photo and video capturing functions, e.g. when pressed in a direction towards the housing. The menu or option button 624a can be used to load a menu or list of options on the display 102a when pressed. In this example embodiment, the escape or cancel button 616a, the menu option button 624a, and a keyboard 620a are disposed on the front face of the mobile device housing, while the convenience button 615a and camera button 617a are disposed at the side of the housing. This button placement enables a user to operate these buttons while holding the mobile device 100a in one hand. The keyboard 620a is, in this example embodiment, a standard QWERTY keyboard, however, it will be appreciated that reduced QWERTY or virtual keyboards (e.g. as provided by a touchscreen display) may equally apply

The example mobile device 100b shown in FIG. 7 includes a touch-screen display 102b, a front camera 702, and a touch-sensitive frame 704. The touch-screen display 102b serves as the position device to provide an input mechanism in addition to display capabilities. The touch-sensitive frame also provides another input mechanism, for example, to control menu options of the mobile device 100b.

It will be appreciated that for the mobile device 100, a wide range of one or more positioning or cursor/view positioning mechanisms such as a touch/track pad, a positioning wheel, a joystick button, a mouse, a touch-screen, a set of arrow keys, a tablet, an accelerometer (for sensing orientation and/or movements of the mobile device 100 etc.), OLED, or other whether presently known or unknown may be employed. Similarly, any variation of keyboard 620 may be used. It will also be appreciated that the mobile devices 100 shown in FIGS. 6 and 7 are for illustrative purposes only and various other mobile devices 100 are equally applicable to the following example embodiments. Other buttons may also be disposed on the mobile device housing such as colour coded “Answer” and “Ignore” buttons to be used in telephonic communications.

To aid the reader in understanding the structure of the mobile device 100, reference will now be made to FIGS. 8 through 10.

Referring first to FIG. 8, shown therein is a block diagram of an example embodiment of a mobile device 100. The mobile device 100 includes a number of components such as a main processor 802 that controls the overall operation of the mobile device 100. Communication functions, including data and voice communications, are performed through a communication subsystem 804. The communication subsystem 804 receives messages from and sends messages to a wireless network 502. In this example embodiment of the mobile device 100, the communication subsystem 804 is configured in accordance with the Global System for Mobile Communication (GSM) and General Packet Radio Services (GPRS) standards, which is used worldwide. Other communication configurations that are equally applicable are the 3G and 4G networks such as EDGE, UMTS and HSDPA, LTE, Wi-Max etc. New standards are still being defined, but it is believed that they will have similarities to the network behaviour described herein, and it will also be understood by persons skilled in the art that the, example embodiments described herein are intended to use any other suitable standards that are developed in the future. The wireless link connecting the communication subsystem 804 with the wireless network 502 represents one or more different Radio Frequency (RE) channels, operating according to defined protocols specified for GSM/GPRS communications.

The main processor 802 also interacts with additional subsystems such as a Random Access Memory (RAM) 806, a flash memory 808, a touch-screen display 810, an auxiliary input/output (I/O) subsystem 812, a data port 814, a keyboard 816, a speaker 818, a microphone 820, a GPS receiver 821, short-range communications 822, a camera 823, a accelerometer 825 and other device subsystems 824. Some of the subsystems of the mobile device 100 perform communication-related functions, whereas other subsystems may provide “resident” or on-device functions. By way of example, the display 810 and the keyboard 816 may be used for both communication-related functions, such as entering a text message for transmission over the network 502, and device-resident functions such as a calculator or task list.

The mobile device 100 can send and receive communication signals over the wireless network 502 after required network registration or activation procedures have been completed. Network access is associated with a subscriber or user of the mobile device 100. To identify a subscriber, the mobile device 100 may use a subscriber module component or “smart card” 826, such as a Subscriber Identity Module (SIM), a Removable User Identity Module (RUIM) and a Universal Subscriber identity Module (USIM). In the example embodiment shown, a SIM/RUIM/USIM 826 is to be inserted into a SIM/RUIM/USIM interface 828 in order to communicate with a network. Without the component 826, the mobile device 100 is not fully operational for communication with the wireless network 502. Once the SIM/RUIM/USIM 826 is inserted into the SIM/RUIM/USIM interface 828, it is coupled to the main processor 802.

The mobile device 100 is typically a battery-powered device and includes a battery interface 832 for receiving one or more rechargeable batteries 830. In at least some example embodiments, the battery 830 can be a smart battery with an embedded microprocessor. The battery interface 832 is coupled to a regulator (not shown), which assists the battery 830 in providing power to the mobile device 100. Although current technology makes use of a battery, future technologies such as micro fuel cells may provide the power to the mobile device 100.

The mobile device 100 also includes an operating system 134 and software components 836 to 846 which are described in more detail below. The operating system 834 and the software components 836 to 846 that are executed by the main processor 802 are typically stored in a persistent store such as the flash memory 808, which may alternatively be a read-only memory (ROM) or similar storage element (not shown). Those skilled in the art will appreciate that portions of the operating system 834 and the software components 836 to 846, such as specific device applications, or parts thereof, may be temporarily loaded into a volatile store such as the RAM 806. Other software components can also be included, as is well known to those skilled in the art.

The subset of software applications 836 that control basic device operations, including data and voice communication applications, may be installed on the mobile device 100 during its manufacture. Software applications may include a message application 838, a device state module 840, a Personal Information Manager (PIM) 842, a connect module 844 and an IT policy module 846. A message application 838 can be any suitable software program that allows a user of the mobile device 100 to send and receive electronic messages, wherein messages are typically stored in the flash memory 808 of the mobile device 100. A device state module 840 provides persistence, i.e. the device state module 840 ensures that important device data is stored in persistent memory, such as the flash memory 808, so that the data is not lost when the mobile device 100 is turned off or loses power. A PIM 842 includes functionality for organizing and managing data items of interest to the user, such as, but not limited to, e-mail, contacts, calendar events, and voice mails, and may interact with the wireless network 502. A connect module 844 implements the communication protocols that are required for the mobile device 100 to communicate with the wireless infrastructure and any host system, such as an enterprise system, that the mobile device 100 is authorized to interface with. An IT policy module 846 receives IT policy data that encodes the IT policy, and may be responsible for organizing and securing rules such as the “Set Maximum Password Attempts” IT policy.

Other types of software applications or components 839 can also be installed on the mobile device 100. These software applications 839 can be pre-installed applications (i.e. other than message application 838) or third party applications, which are added after the manufacture of the mobile device 100. Examples of third party applications include games, calculators utilities, etc.

The additional applications 839 can be loaded onto the mobile device 100 through at least one of the wireless network 502, the auxiliary I/O subsystem 812, the data port 814, the short-range communications subsystem 822, or any other suitable device subsystem 824.

The data port 814 can be any suitable port that enables data communication between the mobile device 100 and another computing device. The data port 814 can be a serial or a parallel port. In some instances, the data port 814 can be a USB port that includes data lines for data transfer and a supply line that can provide a charging current to charge the battery 830 of the mobile device 100.

For voice communications, received signals are output to the speaker 818, and signals for transmission are generated by the microphone 820. Although voice or audio signal output is accomplished primarily through the speaker 818, the display 810 can also be used to provide additional information such as the identity of a calling party, duration of a voice call, or other voice call related information.

Referring now to FIG. 9 the mobile device 100 may display a home screen 940, which can be set as the active screen when the mobile device 100 is powered up and may constitute the main ribbon application. The home screen 940 in this example embodiment generally includes a status region 944 and a theme background 946, which provides a graphical background for the display 102. The theme background 946 displays a series of icons 942 in a predefined arrangement on a graphical background. In some themes, the home screen 940 may limit the number icons 942 shown on the home screen 940 so as to not detract from the theme background 946, particularly where the background 946 is chosen for aesthetic reasons. The theme background 946 shown in FIG. 9 provides a grid of icons It will be appreciated that typically several themes are available for the user to select and that any applicable arrangement may be used. An example icon shown in FIG. 9 is an “AD” icon 951 used to indicate an over-scroll region display application 1100, as will be described below. One or more of the series of icons 942 is typically a folder 952 that itself is capable of organizing any number of applications therewithin, as well as or instead of images, videos, data files, etc.

The status region 944 in this example embodiment includes a date/time display 948. The theme background 946, in addition to a graphical background and the series of icons 942, also includes a status bar 950. The status bar 950 provides information to the user based on the location of the selection cursor 918, e.g. by displaying a name for the icon 953 that is currently highlighted.

An application, such as message application 838 may be initiated (opened or viewed) from display 102 by highlighting a corresponding icon 953 using the positioning device 614a and providing a suitable user input to the mobile device 100. For example, message application 838 may be initiated by moving the positioning device 614a such that the icon 953 is highlighted by the selection box 918 as shown in FIG. 9, and providing a selection input, e.g. by pressing the trackpad 614a.

FIG. 10 shows an example of other software applications and components 839 that may be stored and used on the mobile device 100. Only examples are shown in FIG. 10 and such examples are not to be considered exhaustive. In this example, a web browser application 1054 may be used to access the internet by the user. There is also an address book 1062 that manages and displays contact information. A GPS application 1056 may be used to determine the location of a mobile device 100. A calendar application 1058 that may be used to organize appointments. Another example application is an over-scroll region display application 1100. As will be discussed below, the over-scroll region display application 1100 may be operable to display an advertisement in the over-scroll region 302.

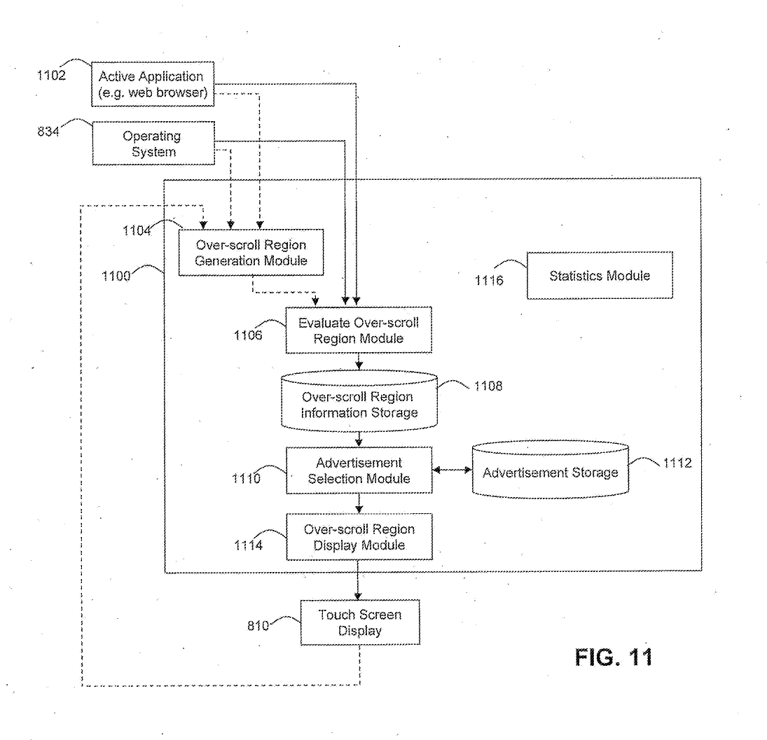

Referring to FIG. 11, an example configuration of the over-scroll region display application 1100 is provided. The over-scroll region display application 1100 can request details of activity occurring in, or receive inputs from, a component that generates an over-scroll region 302 to be displayed, such as the active application 1102 (e.g. web browser 1054) or operating system 834, in order to determine an over-scroll region 302.

In some example embodiments, an over-scroll region 302 is generated by the active application 1102 or operating system 834 and then sent to the over-scroll region display application 1100. in an example embodiment, the operating system 834 can generate over-scroll regions across all applications, including the active application 1102, to implement over-scroll regions system-wide across the mobile device 100 without the need for an active application 1102 to support the feature of displaying over-scroll regions 302.

In another example embodiment, the over-scroll region display application 1100 can generate an over-scroll region 302 For example, the over-scroll region display application 1100 can include an over-scroll region generation module 1104, which is communicable with the operating system 834 to determine graphical user interface information, the active application 1102 to determine the content 104 and its boundaries, and the touch-screen display 810 to determine the scrolling input 300 and display information. Using this information, over-scroll region generation module 1104 can generate an over-scroll region 302 using known methods such as those carried out by the active application 1102 or operating system 834 to generate an over-scroll region 302.

The over-scroll region display application 1100 in the example of FIG. 11 includes an evaluate over-scroll region module 1106 for determining information associated with an over-scroll region 302, which is communicable with a component that generates an over-scroll region 302 such as the operating system 834, or active application 1102. The over-scroll region display application 1100 also includes an over-scroll region information storage 1108 for storing and retrieving information associated with an over-scroll region 302, an advertisement selection module 1110 to determine one or more advertisements to be displayed in an over-scroll region 302, an advertisement storage 1112 for storing and retrieving advertisements, a statistics module 1116 for determining statistical information associated with one or more over-scroll regions 302 and an over-scroll region display module 1114 for instructing the display 810 to display an over-scroll region 302 with one or more advertisements.

The evaluate over-scroll region module 1106 obtains an over-scroll region 302 and determines various information associated with the over-scroll region 302 such as its dimensions, shape, duration and corresponding scrolling input 300. It will be appreciated that the evaluate over-scroll region module 1106 can obtain and evaluate the same over-scroll region 302 repeatedly as it is being displayed, in order to reflect changes in the over-scroll region 302, due to a changing scrolling input 300 for example. The information associated with the over-scroll region 302 is stored in the over-scroll region information storage 1108.

The advertisement selection module 1110 retrieves information associated with an over-scroll region 302 and selects one or more advertisements from the advertisement storage 1112 based on the information associated with the over-scroll region 302. The advertisement selection module 1110 sends the selected one or more advertisements to the over-scroll region display module 1114. The information associated with an over-scroll region 302 can also be obtained from the statistics module 1116 discussed below.

The statistics module 1116 determines statistical information associated with one or more over-scroll regions 302 such as the frequency that an advertisement is displayed, the frequency or magnitude of a scrolling input 300 corresponding to an over-scroll region 302, and the frequency that an advertisement is selected by a user, for example. Furthermore, the statistics module 1116 can organize the information collected based on various criteria such as the component generating an over-scroll region 302 (e.g. different active applications 1102), the specific type of advertisement (e.g. subtle tiled pattern of an image 304 or detailed advertisements with text), and the association of a first advertisement with a second advertisement. The statistical information can be used to determine advertising revenue and allocation of such revenue between the vendor of the operating system 834 and vendors of third-party active applications 1102, for example. In another example embodiment, the statistical information can be used by the advertisement selection module 1110 to select one or more advertisements.

The over-scroll region display module 1114 obtains an advertisement from the advertisement selection module 1110, and send instructions to the display 810 for displaying the over-scroll region 302 with one or more advertisements.

It will be appreciated that any module or component exemplified herein that executes instructions or operations may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data, except transitory propagating signals per se. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the mobile device 100 or accessible or connectable thereto. Any application or module herein described may be implemented using computer readable/executable instructions or operations that may be stored or otherwise held by such computer readable media.

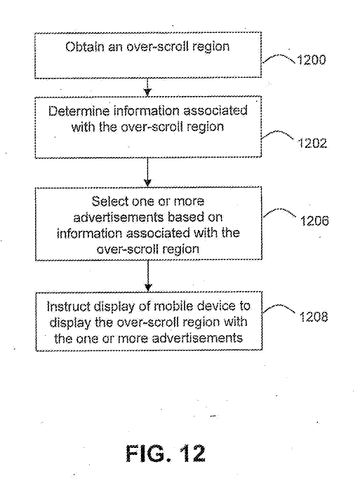

Referring to FIG. 12, an example set of computer executable instructions is provided for displaying an over-scroll region 302 on a mobile device 100. At block 1200, an over-scroll region 302 to be displayed on a mobile device 100 is received or otherwise obtained. For example, the over-scroll region 302 can be generated from a component responsible for the graphical user interface of the mobile device 100 such as the operating system 834 (FIGS. 8 and 11) or active application 1102 (FIG. 11). In another example embodiment, the over-scroll region display application 1100 can generate an over-scroll region 302 using the over-scroll region generation module 1104 (FIG. 11). At block 1202, information associated with the over-scroll region 302 can be determined such as its dimensions, shape, duration and corresponding scrolling input 300. At block 1206, one or more advertisements are selected based on the information associated with the over-scroll region 302. At block 1208, the display 810 (FIGS. 8 and 11) is instructed to display the over-scroll region 302 with the selected one or more of advertisements.

As noted above, an over-scroll region 302 to be displayed on the mobile device 100 is received or otherwise obtained at block 1200. In the example configuration of the over-scroll region display application 1100 (FIG. 11), the over-scroll region 302 may be provided by active application 1102 or operating system 834. It will be appreciated that the over-scroll region 302 can be provided by other components of the mobile device 100 that can generate an over-scroll region 302. In another example embodiment, the over-scroll region 302 can be obtained from the over-scroll region generation module 1104.

At block 1202, information associated with the over-scroll region 302 is determined. In an example configuration, block 1202 may be implemented by the evaluate over-scroll region module 1106 (FIG. 11). The information associated with the over-scroll region 302 can include its dimensions, shape, duration and corresponding scrolling input 300. The specific information to be determined can be dependent on what criteria are used to select one or more advertisements in block 1206.

At block 1206, one or more advertisements is selected based on information associated with the over-scroll region 302. In an example configuration, block 1206 may be implemented by the advertisement selection module 1110 (FIG. 11). In one example embodiment, the advertisement may correspond to a text and/or an image, such as a tiled pattern (or non-tiled pattern) of a symbol, trade-mark or other small image. The dimensions and shape of the over-scroll region 302 determined at block 1202 can be used to determine how to tile a small image 304 in the over-scroll region 302. Referring to the example of FIG. 3, the advertisement includes a tiled pattern of a small image 304. Using a small image 304 can be advantageous because it can require less bandwidth to download and less memory to store on the mobile device 100. Furthermore, displaying a tiled pattern of a small image 304 can provide a subtle form of advertisement without being intrusive to a user, but that can be distinguished from the content 104 to provide a visual indicator that the a boundary 114 of the content 104 has been reached.

At block 1208, the display 810 of the mobile device 100 is instructed to display an over-scroll region 302 with one or more selected advertisements. In an example configuration, block 1208 may be implemented by the over-scroll region display module 1114 (FIG. 11).

In an example embodiment, at block 1202, information associated with an over-scroll region 302 can include information associated with the content 104 displayed on the mobile device 100. For example, the evaluate over-scroll region module 1106 (FIG. 11) can be modified to analyze the content 104 and identify keywords that are frequently used in it. In an example embodiment, at block 1206, the advertisement selection module 1110 (FIG. 11) can select one or more advertisements that are related to the keywords identified at block 1202. It will be appreciated that the information associated with the content 104 can include other information contained in the content 104 such as images, website links and metadata, for example.

In another example embodiment, the over-scroll region display application 1100 can select a different advertisement to be displayed in the over-scroll region 302 if the over-scroll region 302 satisfies one or more criteria. For example, the over-scroll region display application 1100 can change the advertisement of a tiled pattern of a small image 304 to a detailed text-based advertisement upon the over-scroll region 302 exceeding a predetermined size. The over-scroll region display application 1100 can also change the detailed text-based advertisement back to a tiled pattern of a small image 304 upon the over-scroll region 302 falling below a predetermined size. It will be appreciated that the over-scroll region display application 1100 can dynamically change the advertisement In response to changes in the information associated with an over-scroll region 302, such as its dimensions for example.

In another example embodiment, the over-scroll region 302 can display one or more advertisements in different portions of the over-scroll region 302. Referring to the example of FIG. 4, the over-scroll region 302 includes an over-scroll region first portion 404 of a first advertisement, such as a tiled pattern of a small image 304. The over-scroll region 302 also includes an over-scroll region second portion 406 of a second advertisement, such as a website address.

Referring to FIGS. 12 and 4, the over-scroll display application 1100 can divide the over-scroll region 302 at block 1206, based on its dimensions and shape, as determined at block 1202, into the over-scroll region first portion 404 and the over-scroll region second portion 406. For example, block 1206 can select the over-scroll region first portion 404 to be a fixed percentage of the over-scroll region 302. In another example, the over-scroll region first portion 404 can be set to be the over-scroll region 302 up to a predetermined size, after which the over scroll region second portion 406 is set as the excess of the over-scroll region 302 greater than the predetermined size. In an example configuration, the advertisement selection module 1110 (FIG. 11) can select and place the over-scroll region first portion 404 within the over-scroll region 302 such that the over-scroll region first portion 404 is displayed before the over-scroll region second portion 406 in response to the scrolling input 300.

In the example embodiment shown in FIG. 4, the over-scroll region first portion 404 provides a subtle advertisement that also to serves as a visual indicator that the boundary 114 of the content 104 has been reached in response to a scrolling input first stage 400. The continued application of scrolling input 300 (as scrolling input second stage 402) can suggest that the user is interested in more information regarding the advertisement displayed in the over-scroll region first portion 404. Therefore, displaying the over-scroll region second portion 406 including a second advertisement which can be related to the advertisement in the over-scroll region first portion 404, such as a website address or other message, may not be intrusive and may be desirable to the user. The user can control whether the over-scroll region second portion 406 is displayed by applying the further scrolling input 402 to display more of the over-scroll region 302.

Referring to FIG. 12, in another example embodiment, at block 1202, information associated with an over-scroll region 302 can include properties of the corresponding scrolling input 300 that results in the over-scroll region 302. For example, the profile of the scrolling input 300 can be used to select an advertisement at block 1206. In an example embodiment at block 1206, an over-scroll region second portion 406 with a second advertisement can be selected if there is a pause of a predetermined length of time between the scrolling input first stage 400 and the scrolling input second stage 402. The pause in the scrolling input 300 can suggest that the user has observed and considered the advertisement in the over-scroll region first portion 404 and proceeds to apply the scrolling input second stage 402 because the user is interested in more information regarding the advertisement displayed in the over-scroll first region 404.

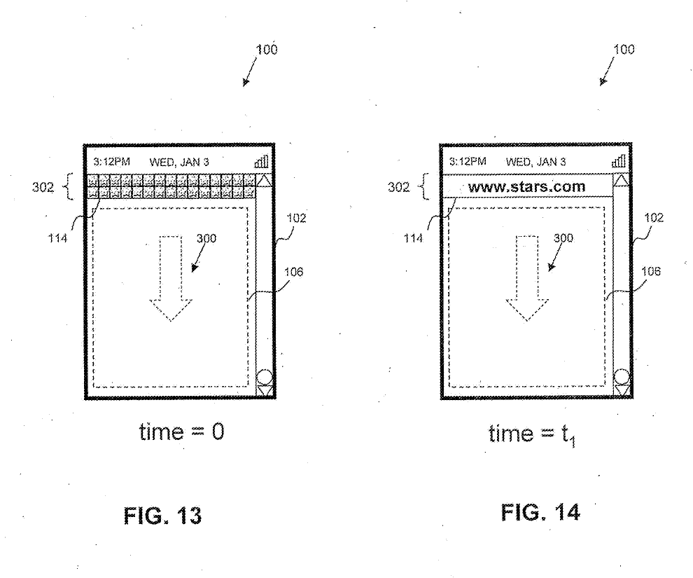

In another example embodiment, selection of the advertisement can be based on timing information associated with the over-scroll region 302 such as how long the over-scroll region 302 has been displayed. In the example of FIGS. 13 and 14, if the over-scroll region 302 has not been displayed for a duration greater than a predetermined length of time t₁, a subtle advertisement such as a tiled pattern of a small image 304 can be displayed (FIG. 13). If the scrolling input 300 is held such that the over-scroll region 302 has been displayed for a predetermined length of time t₁, the over-scroll region 302 can change to display a second advertisement such as a website address (FIG. 14). in the example embodiment of FIGS. 13 and 14, application of the scrolling input 300 to display the over-scroll region 302 for a predetermined length of time t₁ may suggest that the user is interested in more information regarding the advertisement displayed in the over-scroll region 302.

In another example embodiment, the number of times that an over-scroll region 302 or a corresponding scrolling input 300 has been detected can be used to determine when to display the advertising content in the over-scroll region 302, or the nature of the content being displayed. For example, the content within the over-scroll region 302 as shown in FIG. 13 can be displayed for the first X number of over-scroll regions 302 or scrolling inputs 300 detected, and the content as shown in FIG. 14 can be displayed thereafter. The number of times that an over-scroll region 302 or scrolling input 300 has been detected can be tracked by the statistics module 1116.

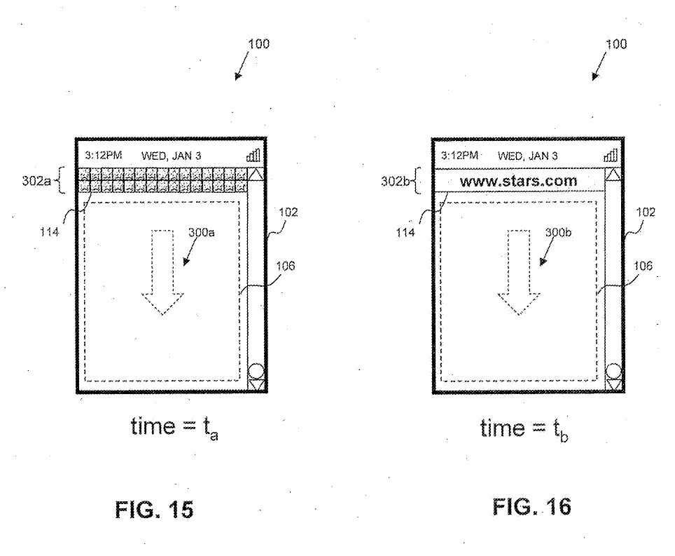

In another example embodiment, selection of an advertisement can be based on the advertisement of the previous over-scroll region 302. In the examples of FIGS. 15 and 16, an over-scroll region 302a can be displayed with an advertisement such as a tiled pattern of an image 304 in response to a scrolling input 300a at a time tₐ. The advertisement of the next over-scroll region 302b in response to the scrolling input 300b at a subsequent time t_{b} can be chosen to be related to the advertisement of the previous over-scroll region 302a if the next scrolling region 302b is displayed within a predetermined length of time of the previous scrolling region 302b or the next scrolling action. In the example embodiment of FIGS. 15 and 16, displaying of the next over-scroll region 302b in close temporal proximity to the previous over-scroll region 302a, or application of the next scrolling input 300b in close temporal proximity to the previous scrolling input 300, can suggest that the user is interested in more information regarding the advertisement displayed in the previous over-scroll region 302.

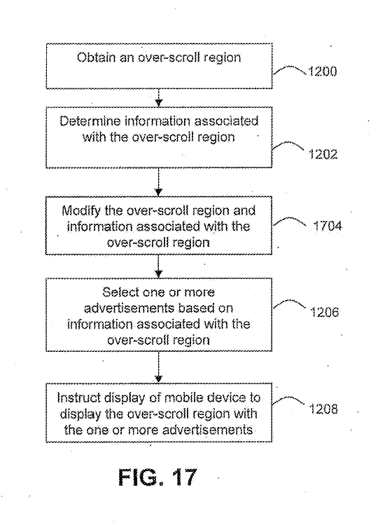

In another example embodiment, the example configuration of the over-scroll region display application 1100 can be modified such that the advertisement selection module 1110 can modify the over-scroll region 302, in addition to selecting one or more advertisements to be displayed, in the over-scroll region 302. Referring to FIG. 17, another example of a set of computer executable instructions is provided for displaying an over-scroll region 302 on a mobile device 100. At block 1200, an over-scroll region 302 to be displayed on the mobile device 100 is received or otherwise obtained. At block 1202, information associated with the over-scroll region 302 can be determined. At block 1704, the over-scroll region 302 and information associated with the over-scroll region 302 can be modified. At block 1706, one or more advertisement are selected based on the information associated with the over-scroll region 302. At block 1208, the display is instructed to display the over-scroll region 302 with one or more advertisements.

Blocks 1200, 1202, 1206 and 1208 as discussed for the example computer executable instructions of FIG. 12 are equally applicable for modifying the over-scroll region 302 and can be used here.

As mentioned above, at block 1704, the over-scroll region 302 can be modified. In an example configuration, block 1704 can be implemented by the advertisement selection module 1110 (FIG. 11). In an example embodiment, the advertisement selection module 1110 can limit the dimensions of the over-scroll region 302 so as to minimize the intrusiveness of an advertisement displayed in the over-scroll region 302 For example, further application of a scrolling input 300 corresponding to an over-scroll region 302 can be ignored after the over-scroll region 302 has reached a predetermined size.

In another example embodiment, the advertisement selection module 1110 can increase the size of the over-scroll region 302 in response to certain criteria of the over-scroll region 302 and/or the scrolling input 300. For example, instead of changing the advertisement displayed in the over-scroll region 302 in the examples of FIGS. 13 and 14 upon satisfying certain criteria such as displaying the over-scroll region 302 for a predetermined length of time the over-scroll region 302 can automatically increase in size such that the existing over-scroll region 302 becomes the over-scroll region first portion 404, and an over-scroll region second portion 406 is added to the over-scroll region 302 to display another advertisement. The advertisement of the over-scroll region second portion 406 can be related to the to the advertisement in the over-scroll region first portion 404.

It will be appreciated that the mobile device 100 can include more than one input device (e.g. trackpad and a touch-screen display) and/or a single input device that can provide more than one input to the mobile device 100 at the same time (e.g. multi-touch touch-screen display). In an example embodiment, the mobile device 100 can receive a scrolling input 300 to display an over-scroll region 302, and a portion of the over-scroll region can be selected by applying a selection input. In an example embodiment, the over-scroll region second portion 406 (FIG. 4) can display a text advertisement (e.g. website address) that can be selected by applying a selection input (e.g. in the case of a multi-touch touch-screen display, using another finger) to open an application installed on the mobile device 100 (e.g. web browser) while the scrolling input 300 is also applied.

In another example embodiment, the advertisement in the over-scroll region second portion 406 can automatically be selected once the scrolling input 300 satisfies certain criteria, such as the scrolling input second stage 402 being of such magnitude as to cause the entire advertisement of the over-scroll second portion 406 to be displayed on the mobile device 100.

As discussed above, the advertisement selection module 1110 can use statistical information determined by the statistics module 1116 to tailor one or more advertisements to the user. Therefore, block 1202 of FIGS. 12 and 17 can include determining statistical information and block 1206 of FIGS. 12 and 17 can include selecting one or more advertisements based on the statistical information. In an example embodiment, the statistical information can be used to associate a first advertisement for display in the over-scroll region first portion 404 with a second advertisement for display in the over-scroll region second portion 406. For example, the advertisement with the greatest likelihood of being selected by the user when associated with the first advertisement can be selected as the second advertisement.

In another example embodiment, statistical information can be used to determine the properties or amount of content of an advertisement in the over-scroll region second portion 406. For example, the average size of the over-scroll region second portion 406 can be used to determine the font size or number of words in the advertisement.

It will be appreciated that the statistical information can include, without limitation, information related to the mean, average, standard deviation, percentage, frequency, probability, correlation, interpolation and extrapolation of information associated with one or more over-scroll regions 302.

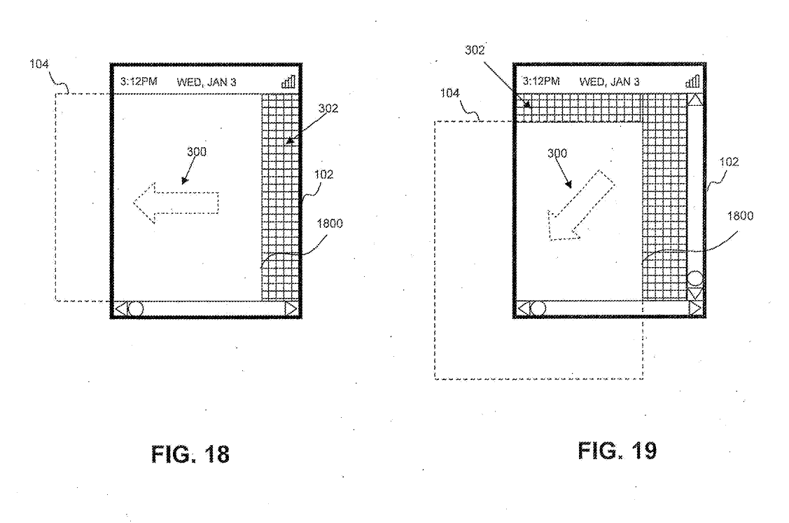

Referring to FIGS. 18 to 19, examples of scrolling inputs 300 that can cause a mobile device 100 to scroll the content 104 past one of its boundaries 1800 are provided. It will be appreciated that the scrolling input 300 can have an arbitrary direction. For example, the scrolling input 300 can provide displacement of content 104 in the vertical direction, horizontal direction (FIG. 18) and diagonal direction (FIG. 19), to display over-scroll region 302.

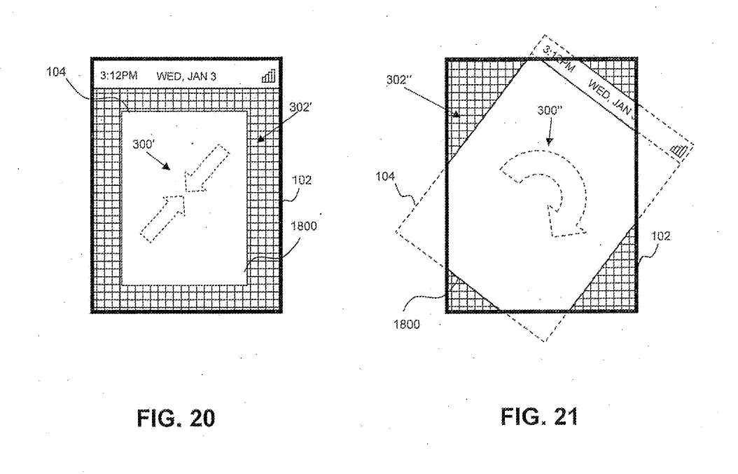

It will be appreciated that other transformations of content 104 can cause one or more of its boundaries 1800 to be displayed within the display 102 of the mobile device 100. The principles expressed herein with respect to over-scroll region 302 are suitable to other transformations such as zooming out (i.e. scaling) of content 104 beyond one or more of its boundaries 1800 (FIG. 20) and rotating content 104 (FIG. 21). For the sake of clarity, it will be understood that reference to an “over-scroll region” also includes reference to over-scaled regions 302′ and over-rotated regions 302″ and that a “scrolling input” includes scaling input 300′ and rotating input 300″, in some example embodiments. For example a rotating input 300″ can include a rotating motion applied to a touch-screen display or changing the physical orientation of the mobile device 100 between portrait and landscape.

It will be appreciated that the examples and corresponding diagrams used herein are for illustrative purposes only Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the spirit of the invention or inventions. For instance, the steps may be performed in a differing order, or steps may be added, deleted, or modified.

Although the above has been described with reference to certain specific example embodiments, various modifications thereof will be apparent to those skilled in the art as outlined in the appended claims.

1. A method of displaying advertising content on a mobile device, the method comprising:
displaying an over-scroll region on a display of the mobile device; and
displaying a first advertisement in at least a first portion of the over-scroll region.

2. The method of claim 1 further comprising determining information associated with the over-scroll region.

3. The method of claim 2 further comprising selecting the first advertisement based on the information associated with the over-scroll region.

4. The method of claim 1, wherein at least a portion of the over-scroll region is selectable.

5. The method of claim 1 further comprising modifying the over-scroll region.

6. The method of claim 5, wherein modifying the over-scroll region comprises increasing or decreasing the size of the over-scroll region.

7. The method of claim 1, wherein the first advertisement comprises a tiled pattern of an image.

8. The method of claim 1, further comprising displaying a second advertisement in a second portion of the over-scroll region.

9. The method of claim 8, further comprising selecting the second advertisement based on the information associated with the over-scroll region.

10. The method of claim 8, wherein the second advertisement is related to the first advertisement.

11. The method of claim 8, wherein the second advertisement comprises text.

12. The method of claim 2, wherein the information associated with the over-scroll region comprises at least one dimension of the over-scroll region.

13. The method of claim 2, wherein the information associated with the over-scroll region comprises one or more properties of a scrolling input corresponding to the over-scroll region.

14. The method of claim 2, wherein the information associated with the over-scroll region comprises at least one of a duration of time and a number of times that the over-scroll region has been displayed.

15. The method of claim 2, wherein the information associated with the over-scroll region comprises a comparison between information associated with the over-scroll region and information associated with another over-scroll region.

16. The method of claim 2, wherein the information associated with the over-scroll region comprises statistical information.

17. The method of claim 2, wherein the information associated with the over-scroll region comprises information associated with content displayed on the mobile device.

18. A computer readable storage medium comprising computer executable instructions for displaying advertising content on a mobile device, the computer executable instructions comprising instructions for:
displaying an over-scroll region on a display of the mobile device; and
displaying a first advertisement in at least a first portion of the over-scroll region.

19. A mobile device comprising a processor coupled to memory and a display, the memory storing computer executable instructions for:
displaying an over-scroll region on the display of the mobile device: and
displaying a first advertisement in at least a first portion of the over-scroll region.

20. The mobile device of claim 19, wherein the display is a touch-screen display.

21. The mobile device of claim 20, wherein the touch-screen display can provide more than one input to the mobile device at the same time.
